(19) United States
(12) Patent Application Publication
(10) Pub. No.: US 2011/0297240 A1
(43) Pub. Date: Dec. 8, 2011

(54) Device for facilitating controlled transfer of flowable material to a site within an interior cavity or vessel, kits containing the same and methods of employing the same

(76) Inventors: Joe Fanelli, Escondido, CA (US); Alan A. Waldman, Oceanside, NY (US)

(21) Appl. No.: 13/134,415

(22) Filed: Jun. 7, 2011

Related U.S. Application Data
(60) Provisional application No. 61/397,226, filed on Jun. 8, 2010.
(60) Provisional application No. 61/517,788, filed on Apr. 26, 2011.

(51) Int. Cl. F15D 1/00

(52) U.S. Cl. 137/14; 137/565.01

(57) ABSTRACT

A device for facilitating controlled transfer of a flowable material to a site within an interior cavity such as a vessel which employs a housing having at least one opening dimensioned and positioned to direct the flowable material rearwardly of the device. Through appropriate application of positive pressure, the device can be used to deliver the flowable material to the cavity or vessel. Apparatus employing the device and methods of using the same are also disclosed.

### RELATED APPLICATIONS

The present Application claims priority from U.S. Provisional Patent Application Ser. No. 61/397,226, filed on Jun. 8, 2010, and U.S. Provisional Patent Application Ser. No. 61/517,788, filed on Apr. 26, 2011, respectively.

### FIELD OF THE INVENTION

The present invention is generally directed to a device for facilitating controlled transfer of flowable material to a site within an interior cavity in a safe, reliable and targeted manner.

### BACKGROUND OF THE INVENTION

It is known in the art to direct a fluid from a source to a nozzle which directs the fluid ahead of or in advance of the nozzle toward a desired target. Such devices are useful for coating vessels such as pipes, tubes and the like which have a continuous inside surface. The device is passed into the vessel, typically along the longitudinal axis into an active position. A fluid is then pumped into the device which typically contains a storage area for receiving the fluid and one or more openings through which the fluid is discharged ahead of the device in a direction toward the continuous inside surface.

While such devices are useful for applying the fluid to the inside surface, they present significant problems when it is desirable to avoid fluid discharge ahead of the device. For example, in the medical field it is desirable to apply a fluid, typically a medication, to the inside surface of an elongated cavity such as the trachea. However, it is undesirable to have the fluid (e.g. medication) discharged ahead of the device because the fluid may undesirably be taken in by the lungs.

It would therefore be a significant advance in the art to provide a device adapted for facilitating the transfer of a flowable material to a site within an interior cavity or vessel in a safe, reliable and targeted manner. It would therefore be a significant advance in the art to provide a device for transmitting a flowable material such as a fluid to the inside surface of a cavity or vessel where the fluid can be prevented from advancing ahead of the device

### SUMMARY OF THE INVENTION

The present invention relates generally to a device adapted for transferring a flowable material to a site within a vessel or cavity. The device of the present invention includes a housing defining an inner volume, where the housing further includes an outer surface having a forward portion and a rearward portion. The device further includes at least one opening disposed in the rearward portion. The opening is suitably positioned for enabling a flowable material to pass freely therethrough. Methods of using the device, including medical and non-medical uses and kits comprising a plurality of such devices and fluid transfer apparatus incorporating such devices form part of the invention.

During operation, the device of the present invention is used for delivering a flowable material to a target site within the interior cavity or vessel. The flowable material, retained within the inner volume of the housing, is delivered through the at least one opening in the direction of the target site located rearwardly of the forward portion of the housing.

In one aspect of the present invention, there is provided a device for transferring a flowable material to a site within an interior cavity or vessel, which comprises:

a housing defining an inner volume, the housing comprising an outer surface;

the outer surface of the housing comprising a forward portion and a rearward portion; and

at least one opening being disposed in the rearward portion of the housing outer surface in fluid communication with the inner volume of the housing, the at least one opening positioned in a manner which enables the flowable material to pass through the opening rearwardly of the forward portion.

The passage of the flowable material is enabled by applying a positive pressure on the flowable material to deliver it to the cavity or vessel.

In a further aspect of the present invention, there is provided an apparatus for transferring a flowable material to a site within an interior cavity or vessel, which comprises:

a) a device as described above having a port for conveying the flowable material to the inner volume of the housing;

b) means for moving the flowable material through the opening; and

c) a tubing operatively connected to the port at one end and to said moving means at a remote end.

In another aspect of the present invention, there is provided a method of transferring a flowable material to a site within an interior cavity or vessel, which comprises inserting the device as described above into the interior cavity or vessel and applying positive pressure to deliver the flowable material to the cavity or vessel.

In another aspect of the present invention, there is provided a kit, which comprises a plurality of the devices described above.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1A is a perspective view of a device for facilitating transfer of a flowable material to or from an interior cavity or vessel in accordance with one embodiment of the device of the present invention;

FIG. 1B is a bottom view of the device shown in FIG. 1A in accordance with the present invention;

FIG. 1C is a top view of the device shown in FIG. 1A in accordance with the present invention;

FIG. 1D is an elevational view of the forward and rearward portions of the device shown in FIG. 1A in accordance with the present invention;

FIG. 1E is a perspective view similar to FIG. 1A showing the angle of tilt (α) of the openings relative to the longitudinal axis of the device in accordance with the present invention;

FIG. 2 is a perspective view of the device for showing another embodiment of the present invention;

FIG. 3 is a perspective view of an apparatus incorporating the device of FIG. 1 specifically adapted for use in the human body in accordance with one embodiment of the present invention; and

FIG. 4 is a schematic view of the inside surface of a vessel and an embodiment of the device for discharging a flowable material to the surface in accordance with the present invention.

### DETAILED DESCRIPTION OF THE INVENTION

The present invention is directed to a device adapted for delivering a flowable material to a site within a vessel or cavity. The device of the present invention includes a housing defining an inner volume, where the housing further includes an outer surface having a forward portion and a rearward portion. The device further includes at least one opening disposed in the rearward portion. The at least one opening is suitably positioned for enabling a flowable material to pass freely therethrough. Methods of using the device, including medical and non-medical uses and kits comprising a plurality of such devices and fluid transfer apparatus incorporating such devices form part of the invention.

During operation, the device of the present invention is used for delivering a flowable material to a target site within the interior cavity or vessel. The flowable material, retained within the inner volume of the housing, is delivered through the at least one opening in the direction of the target site located rearwardly of the forward portion of the housing. As the present invention relates to medical applications, the device of the present invention can be used to deliver any flowable material without causing trauma to any tissue or organs in contact with or in proximity to the present device.

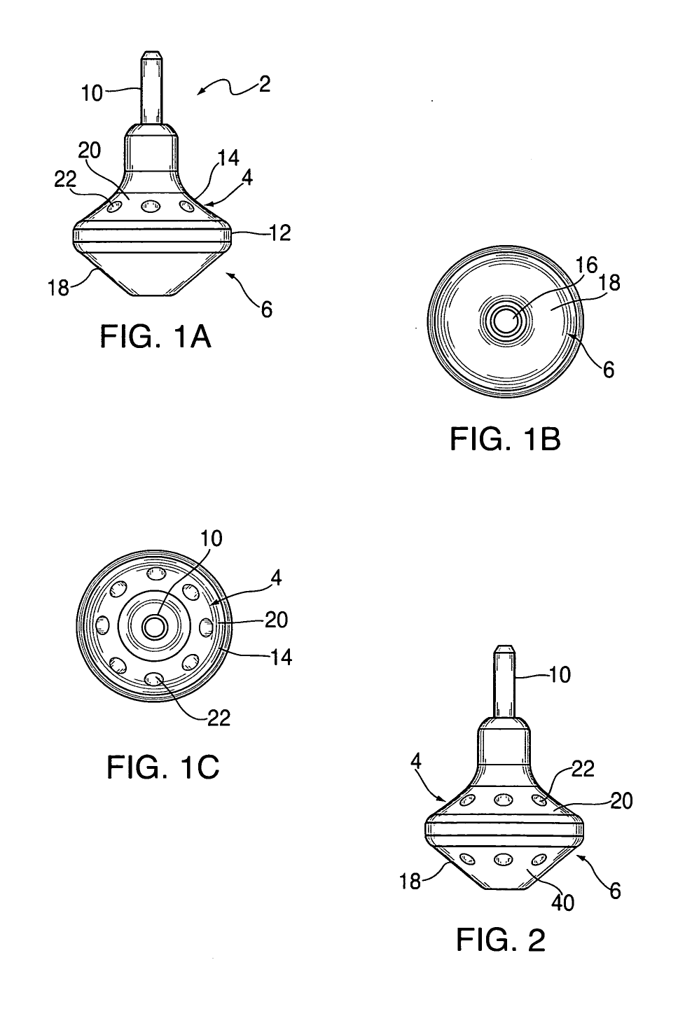

Referring to the drawings and particularly to FIGS. 1A-1D, there is shown an embodiment of device of the present invention identified by the numeral 2. The device 2 includes an upper half referred to herein as a rearward portion 4 and a lower half referred to herein as a forward portion 6 as shown best in FIG. 1D. The two portions 4 and 6 may form an integral unit or may be separable. Together, the rearward and forward portions 4 and 6 form an inner volume 8 through which a flowable material (not shown) passes.

As used herein, the term “flowable material” shall refer broadly to any material, which may be transported to or from a site located within an interior cavity or vessel. The flowable material may be stored in a source for dispensing out of the device toward an inside surface of the interior cavity or vessel. The flowable material is selected from fluids including gases, liquids, fine particle solids, and mixed media materials such as slurries comprised of solids in liquids, as well as emulsions, suspensions and the like. The flowable material may also be selected from fluids, which can readily be atomized as a fine spray.

In medical applications of the present invention, the flowable material when delivered to a interior cavity or vessel, includes, but is not limited to, coating solutions, medications, anesthetics, diagnostic materials and the like.

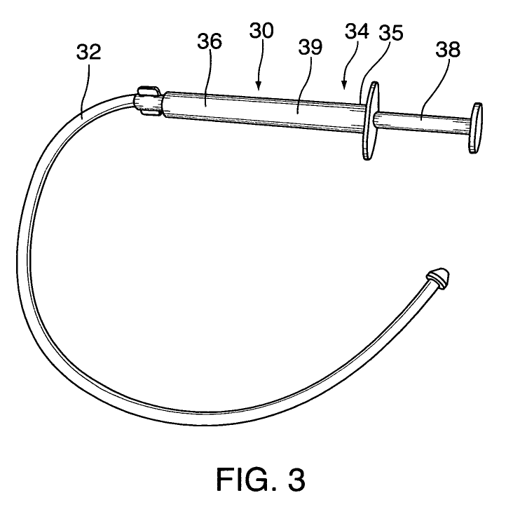

The device 2 has a port 10 through which the flowable material passes from or to the inner volume 8. The port 10 is connected to a pump expelling the flowable material as will be described with reference to FIG. 3. The forward portion 6 of the device and the rearward portion 4 are joined at a center portion 12. Joinder of the two portions when they can be separated from each other may be by a press fit arrangement or by providing the inner surfaces of the two portions with mating threads. The selection of a suitable means of joinder will depend in part on the type of material used to produce the device.

The rearward portion 4 tapers inwardly toward the port 10 forming a rearward tapered surface while the forward portion 6 tapers inwardly toward an end 16 remote from the port 10 thereby forming a forward tapered surface 18. The presence of the rearward tapered surface is important because it provides the site of one or more openings through which the flowable material will be directed rearward of the forward portion 6 during a dispensing operation.

The forward portion 6 of the device as shown in the embodiment of FIGS. 1A-1C has no opening therein and accordingly cannot discharge the flowable material ahead of the device 2. Accordingly, the shape of the forward portion 6 is not critical and may be tapered as specifically shown in FIGS. 1A-1C or assume other shapes such as a cylinder, rectangular solid, cube, polygon and the like. From a manufacturing standpoint, a tapered profile is desired because of the need for less material to form the device.

The rearward portion 4 of the device is tapered so that the rearward tapered or active surface 20 can be fitted with openings 22 in fluid communication with the inner volume 8. The openings 22 are dimensioned and positioned to enable the flowable material to leave the rearward active surface 20 and reach the inside surface of the vessel during a dispensing operation.

The size and position of the openings will depend on such factors as whether all or only a portion of the inside surface of the vessel is to be treated or the rate and configuration of maximizing flow necessary to implement the dispensing operation. For example, if all of the inside surface is to be treated then it is often desirable to have a plurality of openings spaced apart around the entire circumference of the active surface 20. If only a portion of the inside surface of the vessel is to be treated, then it may be desirable to limit the number and position of the openings to only that portion of the active surface which is in proximity to the surface to be treated. In this regard, in a specific embodiment of the invention, a plurality of devices may be included in a kit with at least some of the devices having different distribution patterns of the openings and/or having different sized openings. For example, a kit may contain a plurality of devices with different distributions of openings with openings dimensioned for use in a particular cavity (e.g., trachea). The number of openings will depend in part on the size of the openings and the extent of the surface area of the active surface.

The size of the openings may also depend in part on the nature of the flowable material. Generally, thick materials or materials containing a relatively large amount of solid particles (e.g. slurries and suspensions) will require larger openings than would be required for relatively easily flowable materials such as aqueous solutions.

In treating inside surfaces, where the entire surface is to be treated, it is desirable to employ equally spaced openings having identical or similar sizes. This is because any recoil associated with the discharge of the flowable material through a single opening by the pressure applied to the flowable material will be offset by a similar recoil from an opening in an opposite position.

As previously indicated, the present invention may be used for medical applications as well as non-medical applications such as cleaning pipes of various diameters used to transport chemicals such as petroleum products and the like. Under these circumstances and in these embodiments, the device of the present invention may reach a significant size wherein the device may range from several inches to several feet in length with the openings ranging from less than an inch up to and exceeding one foot in diameter.

It is noted that the present invention is intended to encompass any size, configuration, and shape necessary to facilitate the transfer of flowable material to a site within an interior cavity or vessel, and particularly to discharge the flowable material through the openings with sufficient force to reach the inside surface of the interior cavity or vessel during a dispensing operation.

In medical applications, the device of the present invention can be used to transfer a flowable material to any inside surface of a cavity or vessel found therein, including, but not limited to the trachea, esophagus, vagina, anus, nasal passages, ear canals and the like. For these applications, unlike non-medical applications, the position and dimension of the openings and the size of the device falls within a relative narrow range as described below.

In preferred embodiments of medical applications, the diameter of the center portion 12 will typically be up to 10 mm, more typically 2 to 8 mm. The diameter of the openings will typically be in the range of from about 0.01 mm to 0.1 mm. The number of openings utilized about the entire circumference of the rearward active surface 20 is limited only by the ability to provide openings which are adequately spaced apart from each other. In some applications, the number of openings may be 100 or more, although typically no more than 72 openings will be used. More typically, the number of openings will be from two to eight, more typically from six to eight. Thus, in the typical embodiment for uniform treatment of the entire circumference of a cavity, the openings will be spaced apart around the circumference of the active surface from 180° to 45°, more typically 60° to 45°. Typically, the spacing between openings will be at least 5° (i.e., no more than 72 openings around the circumference).

Another factor is the angle of tilt of the opening measured from the longitudinal axis of the device which in part determines the flow path of the flowable material towards the inside surface of the vessel during the dispensing operation. Referring to FIG. 1E, there is shown an embodiment of the device similar to FIGS. 1A-1C. The longitudinal axis of the device is identified by numeral 24 while the longitudinal axis of an opening 22 in the rearward active surface is identified by numeral 26. The axis 26 is tilted or offset by an angle α which is referred to herein as the angle of tilt. Typically, the angle of tilt (α) will be in the range of from 5° to 80°, more typically from 20° to 60°. The angle of tilt, specifically shown in FIG. 1E, is about 45°.

The device 2 of the present invention is typically provided with a pump assembly to provide a continuous supply of the flowable material from a remote source to a site within the interior cavity or vessel. Referring to FIG. 3, there is shown an apparatus particularly adapted for medical use such as, for example, as an intra-tracheal apparatus 30 for the delivery of an antibiotic for the treatment of the tracheal wall or an irrigation solution for a surgical site.

The apparatus 30 comprises the device 2 of the present invention as previous described connected via the port 10 to a tube 32, which in turn is connected to a pump assembly 34. In the present invention, the pump assembly 34 includes a syringe 35 having a plunger 38 fitting tightly in a tubular body 39 defining a storage area 36 for storing the flowable material (e.g. antibiotic solution) for a dispensing operation. The plunger 38 can used to apply sufficient pressure to the flowable material so that it is evacuated from the storage area 36 into the tube 32 and into the device 2 where it is discharged out of the openings 22 (see FIGS. 1A-1C) in the rearward active surface 20 as previously described.

The amount of pressure necessary to discharge the flowable material through the openings 22 to reach the interior of the cavity or vessel will depend on the size of the openings 22, the viscosity of the flowable material and the distance between the openings and the interior surface. The pressure must be sufficient to enable an operative amount of the flowable material to reach the interior surface, yet be less than that which would cause pressure buildup to the extent that the surge of flowable material through the openings 22 will cause damage to the interior surface of the cavity or vessel or be beyond the pressure limits of the device itself.

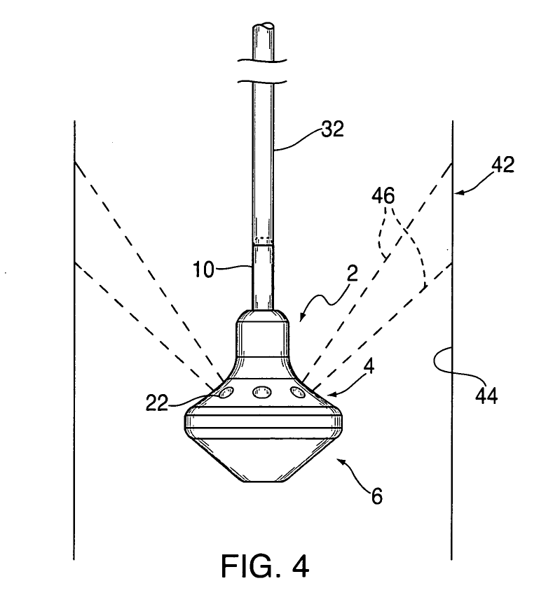

Referring to FIG. 4, the placement of the tube 32 within the trachea 42 centers the device 2 therein so that it is positioned to deliver an antibiotic. When sufficient pressure is applied to the plunger 38 of the syringe 35, the antibiotic is caused to discharge out of the openings 22 in a controlled path 46 as depicted in FIG. 4. As a result, the inside surfaces 44 of the trachea 42 are appropriately treated with the antibiotic.

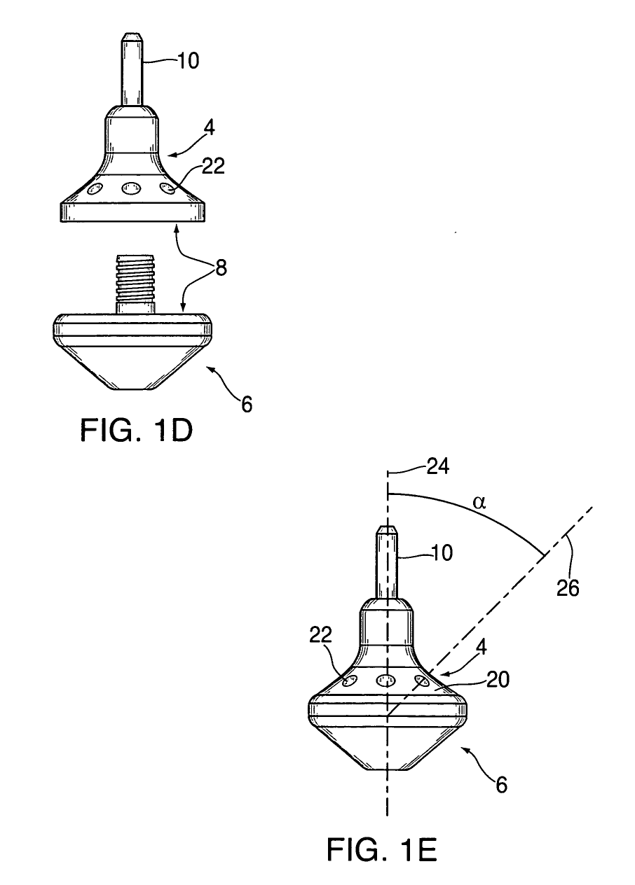

It will be understood that in some medical applications, it is important to prevent discharge of the flowable material ahead of the device. In some applications, forward discharge may be desirable. In such an embodiment of the invention, the forward portion of the device 2 may be provided with openings 40 of the same type described previously for the openings 22 in the rearward portion 4 as shown in FIG. 2.

The device of the present invention may be constructed of any suitable solid material which does not adversely affect the composition of the flowable material including metals (e.g. alumina), alloys (e.g. steel), composites (e.g. fiber reinforced plastics), plastics and the like. For medical applications, the preferred material is medical grade plastic such as polycarbonate (e.g. Makrolon® available from Bayer Material Science).

Construction of the device is within the skill of the art and a preferred means of construction especially for use with plastic materials is to form molds of the device. In producing the molded product, dimples or indentations may be provided where the openings 22 (and 40) appear. The dimples (i.e. indentations) may be easily pierced to provide entry to the cavity when the device is ready for use.

The foregoing discussion discloses and describes merely exemplary embodiments of the present invention. The embodiments depicted herein are illustrative and modifications to such embodiments within the skill of the art are encouraged by the present application. One skilled in the art will readily recognize from such discussion, and from the accompanying drawings and claims, that various changes, modifications and variations can be made therein without departing from the spirit and scope of the invention as defined in the following claims.

What is claimed:

1. A device for transferring a flowable material to a site within an interior cavity or vessel, comprising:
a housing defining an inner volume, said housing comprising an outer surface;
said outer surface of the housing comprising a forward portion and a rearward portion; and
at least one opening being disposed in said rearward portion of the housing outer surface in fluid communication with the inner volume of the housing, said at least one opening positioned in a manner which enables the flowable material to pass through the opening rearwardly of the forward portion.

2. The device of claim 1 comprising a plurality of openings.

3. The device of claim 1 further comprising a pump assembly for urging the flowable material through the at least one opening out of the inner volume.

4. The device of claim 3 wherein the pump assembly comprises:
a pump; and
a cylindrical tube having a pump engaging end and an opposed end connected to the rearward portion.

5. The device of claim 4 wherein the rearward portion comprises a perimeter adjacent a corresponding perimeter of the forward portion, said rearward portion tapering outwardly from the transmitting assembly to the perimeter of the rearward portion.

6. The device of claim 5 comprising a plurality of openings spaced apart from each other in said rearward portion.

7. The device of claim 6 comprising from two to eight openings.

8. The device of claim 7 comprising six to eight openings.

9. The device of claim 6 wherein the housing has a longitudinal axis, said openings being positioned at an angle of tilt from the longitudinal axis in the range of from 5° and 80°.

10. The device of claim 6 wherein the openings are spaced apart from each other a distance equivalent to from 5° to 180° of the circumference of the rearward portion.

11. The device of claim 10 wherein the openings are spaced apart from each other a distance equivalent to from 45° to 180° of the circumference of the rearward portion.

12. The device of claim 11 wherein the openings are spaced apart equidistant from each other.

13. The device of claim 6 wherein the diameter of the openings is in the range of from about 0.01 mm to 0.1 mm.

14. The device of claim 1 wherein the inner volume contains a human tissue acceptable fluid.

15. The device of claim 1 wherein the housing comprises a diameter of up to 10 mm.

16. The device of claim 5, comprising from two to eight openings, positioned at an angle of 5° to 80° from the longitudinal axis of the dispensing assembly and wherein the openings are spaced apart from each other a distance equivalent to from 180° to 45° of the circumference of the rearward surface.

17. The device of claim 1 wherein the flowable material is a fluid.

18. The device of claim 1 wherein the fluid is selected from the group consisting of a gas, a liquid and combinations thereof.

19. The device of claim 1 further comprising flow regulating means for regulating the flow of the flowable material through the housing.

20. The device of claim 1 wherein the flow regulating means correlates the flow of the flowable material based on the size of the openings and the viscosity of the flowable material.

21. The device of claim 1 wherein the rearward portion comprises a first section, having said at least one opening therein and a second section having fewer openings than said first section.

22. The device of claim 1 wherein the second section has no openings therein.

23. A method of transferring a flowable material to a site within an interior cavity or vessel, comprising:
inserting the device of claim 1 into the interior cavity or vessel; and
generating positive pressure to transfer the flowable material to the site.

24. A kit comprising a plurality of the devices of claim 1.

25. The kit of claim 24 wherein the plurality of devices each comprise a housing with a different distribution pattern of openings.

26. The kit of claim 24 wherein the plurality of devices are suitable for treating a particular type of cavity.

27. An apparatus for transferring a flowable material to a site within an interior cavity or vessel, comprising:
a) a device of claim 1 having a port for conveying the flowable material to the inner volume of the housing;
b) means for moving the flowable material through the opening; and
c) a tubing operatively connected to the port at one end and to said moving means at a remote end.
